(19) United States
(12) Patent Application Publication
(10) Pub. No.: US 2012/0080532 A1
(43) Pub. Date: Apr. 5, 2012

(54) TEMPERATURE CONDITIONING SYSTEM FOR OUTDOOR DIGITAL SIGNAGE AND METHOD THEREOF

(76) Inventors: Jui-Hung TAI, Hsinchu (TW); Jing-Lin Zhang, Hsinchu (TW); Shen-Hsiung Chou, Hsinchu (TW); Ding-Hua Ting, Hsinchu (TW)

(21) Appl. No.: 12/897,858

(22) Filed: Oct. 5, 2010

(51) Int. Cl. F24F 11/00; H05B 1/00; H05B 1/02

(52) U.S. Cl. 236/49.3; 219/490; 219/201

(57) ABSTRACT

A temperature conditioning system for outdoor digital signage and method thereof comprises a central control module, a system temperature sensor, a fan temperature sensor, a digital signage control module, an internal power supply module, a display module, a heating module and an external fan, wherein the central control module is responsible for receiving temperature signals detected by the system temperature sensor and the fan temperature sensor; in case the detected temperature is lower than a certain range, the central control module activates the heating module, the external fan and the display module in order to start and display the warm-up process of the outdoor digital signage. Consequently, when the temperature elevates to a certain range, the digital signage control module activates the power source of the outdoor digital signage such that the outdoor digital signage operates within a normal temperature range thereby preventing the dew formed by excessively low outdoor temperature from causing malfunction problems in the outdoor digital signage.

### BACKGROUND OF THE INVENTION

1. Field of the Invention

The present invention relates to a temperature conditioning system for outdoor digital signage and method thereof; in particular, it relates to a temperature conditioning system for outdoor digital signage thereby allowing the outdoor digital signage to operate within a normal temperature range so as to prevent occurrence of malfunction problems in the outdoor digital signage due to low temperature.

2. Description of Related Art

Outdoor advertisement is a type of advertisement medium of long history, having been developed from wood bulletin boards in earlier age to currently mainstreamed digital signage, now gradually favored by numerous advertisers. Along with consistent evolutions with regards to commercial models of digital advertisement, including various applications found in the multi-purpose display utilized in the public transportation system or emergency report system, the general information publication system commonly used in academic campuses as well as electronic menu signage and so forth, it can be observed that the demand for outdoor digital displays keeps increasing so as to fulfill constant needs in terms of no matter information distributions or promotions of commercial activities.

Therefore, in addition to a variety of indoor applications, the digital signage also enables outdoor applications such as bus stop displays, outdoor train station/platform notifications, metropolitan road signs, street advertisements etc., and numerous liquid crystal displays (LCDs) and plasma displays of different manufacturers are introduced into comprehensive outdoor digital signage applications. However, to be used as an apparatus for outdoor digital signage, it is still very challenging for currently available LCDs and plasma displays. For example, in terms of adaptability under various climate conditions, suppose the outdoor temperature is relatively low, dews caused by moisture condensation tend to be formed on LCDs or plasma displays because of ambient temperature variations, and dews generated in such a way possibly lead to problems like component damages or rusts in mechanical structure. Consequently, it is highly desirable to develop a practical solution for applying such type of electronic devices as the outdoor digital signage capable of adapting to a variety of climate conditions.

Accordingly, a temperature conditioning system for outdoor digital signage and method thereof which installs a temperature conditioning system in the outdoor digital signage thereby effectively adjusting the internal temperature of the outdoor digital signage and reducing the influence thereon caused by environmental temperature variations can be an optimal solution.

### SUMMARY OF THE INVENTION

An objective of the present invention is to provide a temperature conditioning system for outdoor digital signage and method thereof which installs a temperature conditioning system in the outdoor digital signage thereby maintaining the internal temperature of the outdoor digital signage to be within a normal operation range.

Another objective of the present invention is to provide a temperature conditioning system for outdoor digital signage and method thereof which maintains normal operations in the outdoor digital signage with a temperature conditioning system thereby preventing the dew formed by the low temperature from damaging the body and also reducing maintenance costs for the outdoor digital signage.

A temperature conditioning system for outdoor digital signage and method thereof capable of achieving the aforementioned objectives comprises a central control module, an internal power supply module, a system temperature sensor, a fan temperature sensor, a digital signage control module, a display module, a heating module and an external fan, wherein the central control module is responsible for receiving the temperatures detected by the system temperature sensor and the fan temperature sensor; in case the detected temperature is lower than a certain range, the central control module activates the heating module, the external fan and the display module in order to start and display the warm-up process of the outdoor digital signage. Consequently, when the temperature elevates to a certain range, the digital signage control module activates the power source of the outdoor digital signage such that the outdoor digital signage operates within a normal temperature range thereby preventing the dew formed by excessively low outdoor temperature from causing malfunction problems in the outdoor digital signage.

More specifically, if the temperature detected by the above-said fan temperature sensor is lower than a certain range, then the external fan will operate conjunctively with the heating module to constitute a heated airflow circulation so as to allow the heating module to achieve the purpose of heating more efficiently.

More specifically, if the temperature detected by the above-said fan temperature sensor is in an extremely low condition, then, with a view to protecting the external fan, the external fan stops operating and the heating module continues its heating operation.

More specifically, as the heating module being used to heat, the above-said display module will blink thereby indicating that the warm-up process is being performed inside the outdoor digital signage.

### BRIEF DESCRIPTION OF THE DRAWINGS

FIG. 1 shows an architectural diagram of a temperature conditioning system for outdoor digital signage and method thereof according to the present invention;

FIG. 2 shows a control flowchart of a temperature conditioning system for outdoor digital signage and method thereof according to the present invention; and

FIG. 3 shows another control flowchart of a temperature conditioning system for outdoor digital signage and method thereof according to the present invention.

### DETAILED DESCRIPTION OF THE PREFERRED EMBODIMENTS

The aforementioned and miscellaneous technical contents, features and effects of the present invention can be clearly appreciated through illustrating the following detailed descriptions for preferred embodiments of the present invention with reference to the appended diagrams thereof.

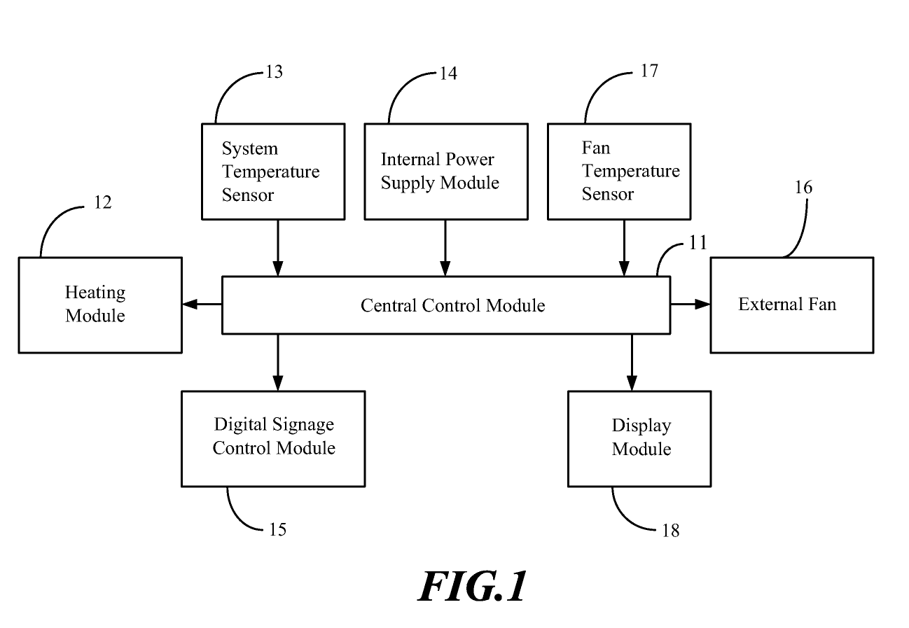

Refer initially to FIG. 1, wherein an architectural diagram of a temperature conditioning system for outdoor digital signage and method thereof according to the present invention is shown, in which the temperature conditioning system is installed in an outdoor digital signage, and from FIG. 1 it can be seen that the temperature conditioning system comprises:
a central control module 11, which is used to determine and handle the inputted signal;
a heating module 12, which is interfaced with the central control module 11 in order to perform the warm-up process inside the outdoor digital signage;
a system temperature sensor 13, which is interfaced with the central control module 11 in order to detect the internal temperature of the outdoor digital signage and transfers an internal temperature signal to the central control module 11, and if the detected temperature is lower than a certain range, then the central control module 11 activates the heating module 12;
an internal power supply module 14, which is interfaced with the central control module 11 in order to provide the electric power needed for operations of the central control module 11;
a digital signage control module 15, which is interfaced with the central control module 11 in order to control the power on/off of the outdoor digital signage.

It should be noticed that it is possible to additionally install an external fan 16 to the temperature conditioning system in which the external fan 16 is interfaced with the central control module 11 in order to, as the heating module 12 performing the heating process, conjunctively operate and form a heated airflow circulation thereby facilitating the heating module 12 to heat up more efficiently.

It should be noticed that it is possible to additionally install a fan temperature sensor 17 to the temperature conditioning system in which the fan temperature sensor 17 is interfaced with the central control module 11 in order to detect the temperature of the external fan 16 and transfer a fan temperature signal to the central control module 11, and if the detected temperature is lower than a certain range, then the central control module 11 activates the external fan 16.

It should be noticed that if the temperature detected by the fan temperature sensor 17 is in an extremely low condition, then, with a view to protecting the external fan 16, the external fan 16 stops operating and the heating module 12 continues its heating operation.

It should be noticed that it is possible to additionally install a display module 18 to the temperature conditioning system in which the display module 18 blinks as the heating module 12 being used to heat thereby indicating that the warm-up process is being performed inside the outdoor digital signage.

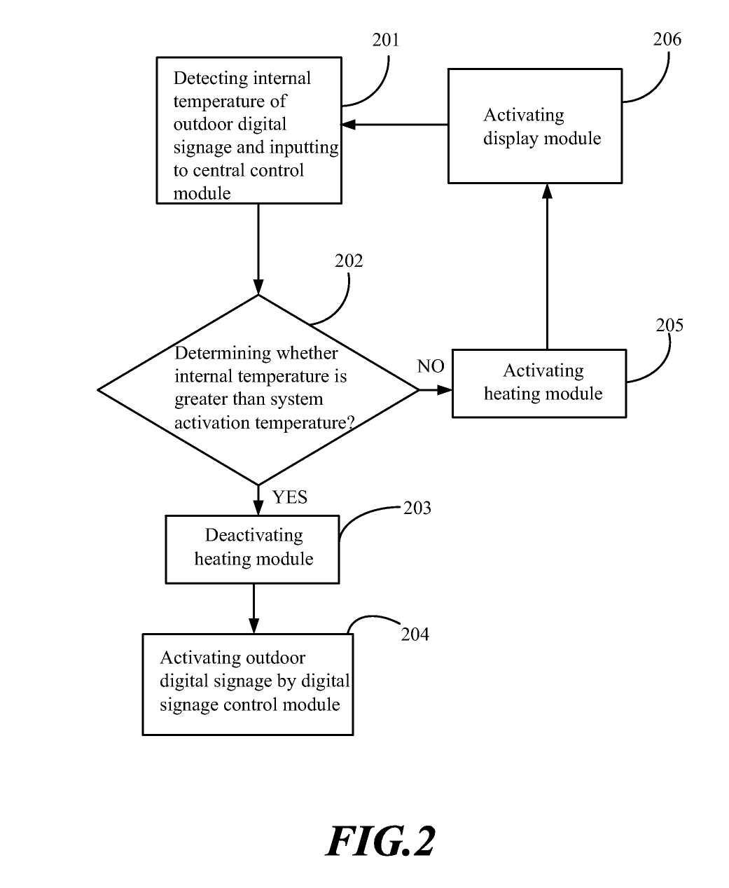

Refer next to FIG. 2, wherein a control flowchart of a temperature conditioning system for outdoor digital signage and method thereof according to the present invention is shown. It can be seen from FIG. 2 that the method of temperature conditioning comprises the following steps:

1. detecting the internal temperature of the outdoor digital signage with the system temperature sensor and transferring an internal temperature signal to the central control module (201);

2. determining by the central control module whether the internal temperature of the outdoor digital signage is greater than a system activation temperature (e.g., greater than 0° C.) (202); if yes, then deactivating the heating module (203) and activating the outdoor digital signage by the digital signage control module (204);

3. if the internal temperature of the outdoor digital signage is not greater than the system activation temperature (e.g., less than or equal to 0° C.), then activating the heating module to perform the warm-up process (205), and next activating the display module to indicate that the outdoor digital signage is currently performing the warm-up process internally (206);

4. repeating STEP 1, until the internal temperature of the outdoor digital signage becomes greater than the system activation temperature.

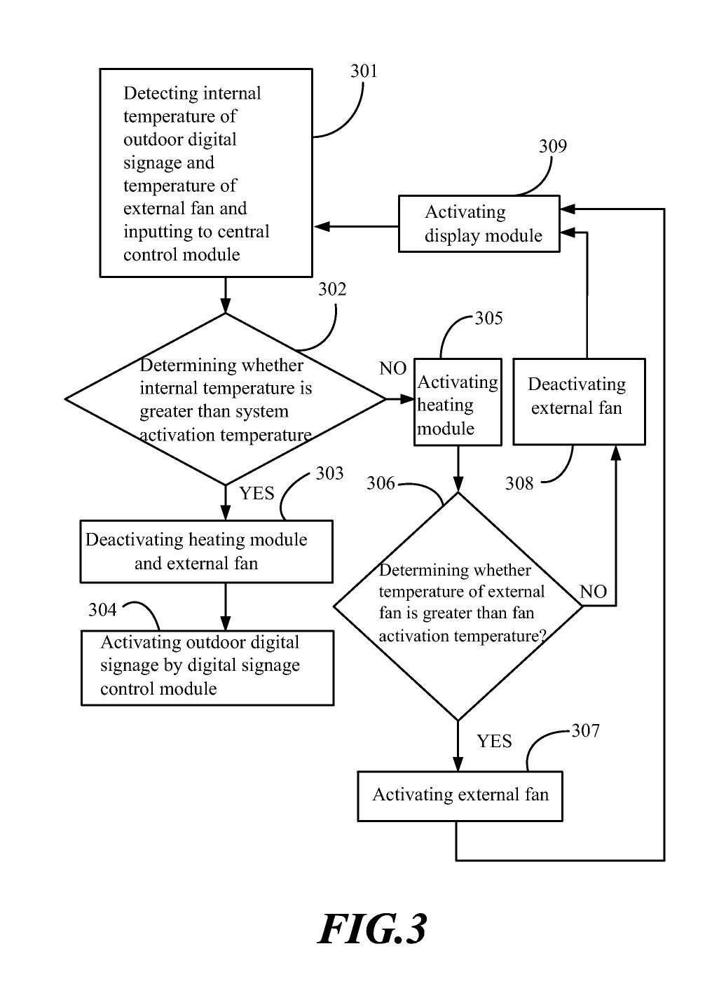

Refer now to FIG. 3, wherein another control flowchart of a temperature conditioning system for outdoor digital signage and method thereof according to the present invention is shown. It can be seen from FIG. 3 that the method of temperature conditioning comprises the following steps:

1. detecting the internal temperature of the outdoor digital signage with the system temperature sensor and detecting the temperature of the external fan with the fan temperature sensor, and then transferring an internal temperature signal and an external fan temperature signal to the central control module (301);

2. determining by the central control module whether the internal temperature of the outdoor digital signage is greater than a system activation temperature (e.g., greater than 0° C.) (302); if yes, then deactivating the heating module and the external fan (303) and activating the outdoor digital signage by the digital signage control module (304);

3. if the internal temperature of the outdoor digital signage is not greater than the system activation temperature (e.g., less than or equal to 0° C.), then activating the heating module to perform the warm-up process (305);

4. determining by the central control module whether the temperature of the external fan is greater than a fan activation temperature (e.g., greater than −20° C.) (306); if yes, then powering on the external fan (307), and next activating the display module to indicate that the outdoor digital signage is currently performing the warm-up process internally (309);

5. if the temperature of the external fan is not greater than the fan activation temperature (e.g., less than or equal to −20° C.), then deactivating the external fan (308), and next activating the display module to indicate that the outdoor digital signage is currently performing the warm-up process internally (309);

6. repeating STEP 1, until the internal temperature of the outdoor digital signage becomes greater than the system activation temperature.

It should be noticed that, as activating the heating module, the display module is simultaneously activated (307) thereby indicating that the outdoor digital signage is currently performing the warm-up process internally.

Compared with other conventional technologies, the temperature conditioning system for outdoor digital signage and method thereof according to the present invention provides the advantages as below:

1. The present invention features the installation of a temperature conditioning system in the outdoor digital signage such that the internal temperature of the outdoor digital signage is allowed to be maintained within a normal operation range, thereby preventing the dew formed by low temperature from damaging the body and also reducing maintenance costs for the outdoor digital signage.

2. The present invention enables, in applying the outdoor digital signage to various outdoor environments, automatic adjustment on the internal temperature of the outdoor digital signage for desirable adaptability to different climate conditions such that the outdoor digital signage is activated only after that the internal temperature thereof reaches the system activation temperature.

3. The present invention is allowed to operate conjunctively with an external fan such that, during performance of warm-up process in the outdoor digital signage, the heated air flow inside the outdoor digital signage can be accelerated by means of the external fan thereby forming a heated airflow circulation to make the heating process more efficient.

Through the aforementioned detailed descriptions of the preferred embodiments according to the present invention, it is intended that the characteristics and features of the present invention can be better illustrated and appreciated, rather than limiting the scope of the present invention by the preferred embodiments disclosed as above. Contrarily, it is desired that all effectively equivalent changes, modifications or substitutions made thereto are encompassed by the scope of the present invention as delineated in the claims set forth hereunder.

What is claimed is:

1. A temperature conditioning system for outdoor digital signage, in which the temperature conditioning system is installed in an outdoor digital signage and the temperature conditioning system comprises:
a central control module, which is used to determine and handle the inputted signal;
a heating module, which is interfaced with the central control module in order to perform the warm-up process inside the outdoor digital signage;
a system temperature sensor, which is interfaced with the central control module in order to detect the internal temperature of the outdoor digital signage and transfers an internal temperature signal to the central control module;
an internal power supply module, which is interfaced with the central control module in order to provide power needed for operations of the central control module;
a digital signage control module, which is interfaced with the central control module in order to control the power on/off of the outdoor digital signage.

2. The temperature conditioning system for outdoor digital signage according to claim 1, wherein an external fan is additionally installed to the temperature conditioning system in which the external fan is interfaced with the central control module in order to, as the heating module performing the heating process, conjunctively operate and form a heated airflow circulation.

3. The temperature conditioning system for outdoor digital signage according to claim 2, wherein a fan temperature sensor is additionally installed to the temperature conditioning system in which the fan temperature sensor is interfaced with the central control module in order to detect the temperature of the external fan and transfer a fan temperature signal to the central control module.

4. The temperature conditioning system for outdoor digital signage according to claim 1, wherein a display module is additionally installed to the temperature conditioning system in which the display module blinks as the heating module being used to heat thereby indicating that the warm-up process is being performed inside the outdoor digital signage.

5. A method of temperature conditioning for outdoor digital signage, comprising the following steps:
1. detecting the internal temperature of the outdoor digital signage with the system temperature sensor and transferring an internal temperature signal to the central control module;
2. determining by the central control module whether the internal temperature of the outdoor digital signage is greater than a system activation temperature; if yes, then deactivating the heating module and activating the outdoor digital signage by the digital signage control module;
3. if the internal temperature of the outdoor digital signage is not greater than the system activation temperature, then activating the heating module to perform the warm-up process, and next activating the display module to indicate that the outdoor digital signage is currently performing the warm-up process internally;
4. repeating STEP 1.

6. The method of temperature conditioning for outdoor digital signage according to claim 5, wherein, after activation of the heating module, further activating a display module in order to indicate that the outdoor digital signage is performing the warm-up process internally.

7. The method of temperature conditioning for outdoor digital signage according to claim 5, wherein further detecting the temperature of an external fan with a fan temperature sensor and transferring an external fan temperature signal to the central control module.

8. The method of temperature conditioning for outdoor digital signage according to claim 7, wherein, when the internal temperature of the outdoor digital signage is greater than the system activation temperature, the external fan is deactivated.

9. The method of temperature conditioning for outdoor digital signage according to claim 7, wherein, after activation of the heating module, further determining by the central control module whether the temperature of the external fan is greater than a fan activation temperature; if yes, activating the external fan; otherwise, deactivating the external fan.
